(19) United States
(12) Patent Application Publication
(10) Pub. No.: US 2008/0189366 A1
(43) Pub. Date: Aug. 7, 2008

(54) Online Social and Professional Networking and Collaboration Services with Enhanced Communications Capabilities

(76) Inventors: Richard D. Cox, Garland, TX (US); Stephen J. Metzger, Dallas, TX (US); Scott M. Yagel, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/958,338

(22) Filed: Dec. 17, 2007

Related U.S. Application Data
(60) Provisional application No. 60/870,359, filed on Dec. 15, 2006.
(60) Provisional application No. 60/871,423, filed on Dec. 21, 2006.

(51) Int. Cl. G06F 15/16

(52) U.S. Cl. 709/204

(57) ABSTRACT

A virtual collaboration social or work unit or sphere of trust allows participants to contact others within the sphere, using a method designated by the participant being contacted without the participants needing to be aware of the underlying communications infrastructure or method of contact, and without any of the participants having to sharing connectivity information. In a preferred embodiment, the infrastructure can be any method of contact available to the users, including but not limited to, the public Internet, instant messaging, public or private telephony systems, or wireless communication technologies.

### CROSS-REFERENCE TO RELATED APPLICATIONS

This application claims the benefit of U.S. provisional application No. 60/870,359, filed Dec. 15, 2006 and U.S. provisional application No. 60/871,423, filed Dec. 21, 2006, each of which is incorporated herein by reference.

### TECHNICAL FIELD

This disclosure relates generally to computer based systems for collaboration and unified communications.

### BACKGROUND

A large number of services on the Internet offer varying types of collaborative mechanisms. Similarly, a large number of social networking websites enable creation and maintenance of one-on-one and group relationships.

### SUMMARY

The disclosure is generally directed to improved methods and apparatus for bringing together a number of people into a social or business network with one or more common interests (a “sphere of trust”). One of the obstacles to doing so is the various methods of contact and standards for each of the communications alternatives available to each user. In addition, users may not wish to have their communications connectivity information be made public, even to those within the same sphere of trust.

Different aspects of a preferred embodiment of an exemplary application of the invention help to enable bringing together people with a common interest into an on-line virtual collaboration social or work unit or sphere of trust that allows participants to contact others within the sphere, using a method designated by the participant being contacted, without the participants needing to be aware of the underlying communications infrastructure or method of contact, and without any of the participants having to sharing connectivity information. In a preferred embodiment, the infrastructure can be any method of contact available to the users, including but not limited to, the public Internet, instant messaging, public or private telephony systems, or wireless communication technologies.

### BRIEF DESCRIPTION OF THE DRAWINGS

FIG. 1 is a screen shot of a web browser that comprises a representative example of an interface to an on-line virtual meeting room service.

FIG. 2 illustrates a flow diagram of a representative example of a process of using the virtual meeting room service.

FIG. 3 comprises a screen of a web browser interface for providing user information to the virtual meeting room service.

FIG. 4 comprises a schematic diagram of a virtual meeting room server for the service, and connections between a virtual meeting room server, a unified messaging system and clients of members in communication with the server.

### DETAILED DESCRIPTION OF EXEMPLARY EMBODIMENTS

A preferred embodiment of the invention is described below in reference to a virtual meeting room service. A virtual meeting room service is an example to which various teachings of the invention can be advantageously employed. Unless otherwise expressly stated in a claim, the invention is not limited to a virtual meeting room service and could be embodied in other types of social and/or professional networking services and platforms.

In the following description, like numbers refer to like elements.

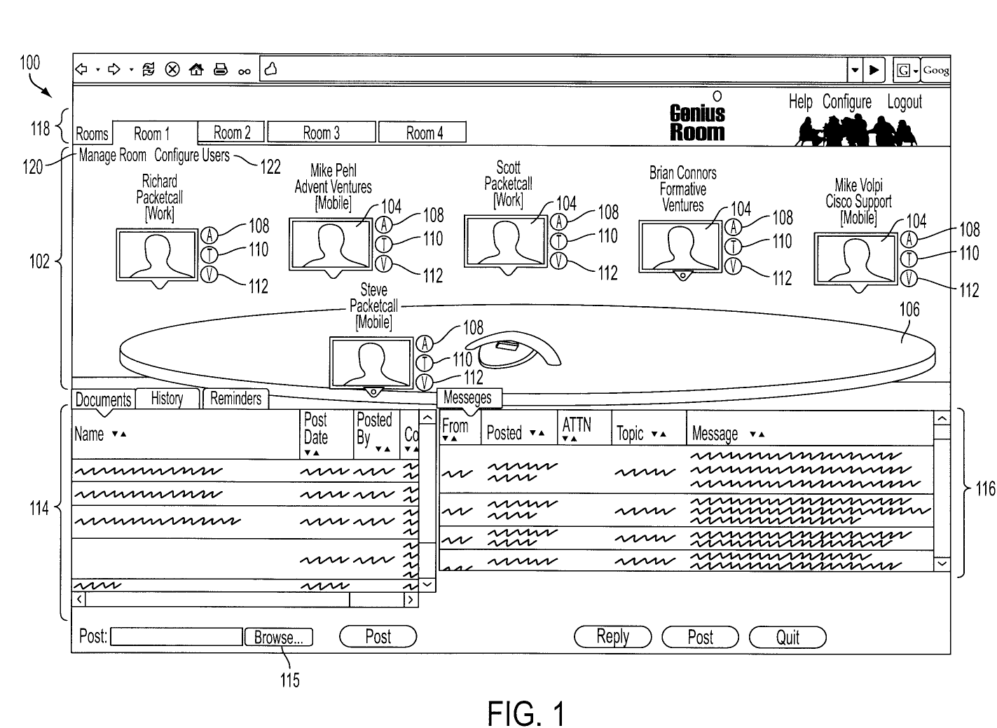

Referring to FIG. 1, illustrated is a screen-shot of a representative example of a client interface 100 for a virtual meeting room service. In this example, a web browser is displaying a web page created by a virtual meeting room server for a particular member of the virtual meeting room. A different web page is served to each member. A dedicated client application, a plug-in or similar adaptation to an existing application, or other types of presentation mechanisms could also be used to connect to a virtual meeting room server.

Each room represents a group of users who are part of a sphere of trust between members. Typically, these users might be employees of an organization who are working together on a project or an issue. It contemplates the possibility of internal members as well as external members, who are outside the usual sphere of trust, such as experts or other participants with various level of ability to interact with the internal members.

Web page 100 includes in area 102 representations of each individual who is a member of the meeting room. The representations could be, for example, simply a name or other identifier. Associated with each member representation are indications of availability and presence. If a member is “available,” it means that the member has provided contact information for members of this room to contact the member. Contact information includes, for example, standard telephone numbers, universal location identifiers, instant messaging (IM) addresses, and email addresses. The communication medium could be text, voice or video. The actual contact information is not, however, displayed. “Presence” means that the person is present in the virtual meeting room. In the embodiment described herein, presence is detected or determined by whether a member is logged into the server. This presence detection mechanism could be augmented or replaced by a mechanism to test whether a member is, in fact, present at a computer, without a client interface open. Examples include automated log-off in the event of inactivity for a specified period of time and programs to detect whether the window of the web browser or client application is activated or in front.

It is preferred that area 102 represents a virtual environment that mimics an appropriate real-world meeting environment. In this example, areas 104 hold photographs or other graphical representations of members. The name of each individual and the company or organization with which the individual is affiliated are also displayed next to the photograph. The photos are arranged around the representation of a conference table 106. Next to each photograph are three icons. Icon 108 indicates whether or not the person is available to be contacted by members of the virtual meeting room. Icon 110 represents whether the person is present in the virtual meeting room. Icon 112 indicates whether the person is busy. In the preferred embodiment, icon 112 is indicated as being busy only when the member is on a call with another member of the same room, and not when they might be on a call with a member of a different room.

Web browser pages can be customized so that users feel comfortable with the use, operation, look, and feel of the service. Furthermore, more elaborate virtual environments can be utilized. For example, an avatar capable of moving around the room could represent each of the members. Presence could be indicated by moving the avatar into the room; absence could be indicated by a still photograph or icon. A conversation occurring between only certain members of a room could be represented by avatars for those members moving to one side of the room.

In a preferred embodiment, members may upload or post files or links to files (for example, in an external document repository) for sharing. These files are made available only to members of the room. Files that are uploaded are listed on a window that is displayed within section 114 of the main web page when the tab “Document” is selected. Included with the name of the file are preferably also the date of posting, the name of the member posting it, and comments describing the file. Files can be downloaded or, optionally, viewed within the browser. Members preferably also are enabled to search internal or external document repositories and post a reference to the document so that other members can view the document within the context of the room. A “browse” selector 115 is provided so that the member can search for documents on any connected repository. Audio files (recordings) can be attached as a document, as well as telephone conversation recordings. All documents are accessible (sight and sound) to all members of the room, unless marked by an internal member from being viewed by an external member of the room.

Members that are currently logged into the virtual meeting room server can post text messages using the text messaging section 116. Messages posted by members are displayed in section 116 of the main browser screen and made available to all members. Although not illustrated, a preferred embodiment allows messages to be directed to designated members, which will be displayed only to those members. In essence, these are private messages. Finally, a preferred embodiment also includes an on-line chat mechanism. Although not illustrated in FIG. 1, the on-line chat appears in a sub-window within the interface. It is preferred that on-line chats be saved, and thus persist, like the messages. However, optionally, the virtual meeting room service could be adapted to permit discarding of chat sessions. These messages may be directed toward individual members or to the room. Each member may set preferences for whether or not to be notified of new files and messages. Notification may take place by email, text messaging (to a mobile telephone, for example), or other communication mechanism. Text messages can be relayed to external Instant Messaging (IM) systems, such as Yahoo, Google, and AOL, via the method's IM gateways. These messages can be sent with or without a specified topic. All messages are viewable by all members of the sphere, unless marked as ‘eyes only’ by an internal member, which will shield the information from viewing by an external member of the sphere. Messages can be sorted by column and a search can be performed on text within the messages. Selecting the “History” tab in window 114 displays in the window a history of predetermined types of events associated with the room. The events include, in the preferred embodiment, dates and times of file posting, calls, and messages. Members are able, preferably, to view and search the history of any room of which they are a member. Selecting the tab “Reminders” in window 114 displays a list, to which members may post timed reminders to other members. File and message posting are just examples of basic functionality of the virtual room. The collaboration functionality of the service can be extended with additional capabilities and services or integrated with on-line third party services.

The virtual meeting room service preferably is capable of allowing a member to integrate the capabilities of the virtual meeting room service with commercial desktop applications, such as calendars, meeting applications, and word processors. For example, by selecting to import reminders from a room to a calendar application, the member can be reminded of assigned tasks in the sphere even when he or she is not logged into the method's application.

In one preferred embodiment, the processes may include a “stealth” mode, for executive and/or other authorized users. In this mode, a member can view all, or selected, activities occurring in one or more spheres without knowledge of the other members of the sphere.

Each user can be a member of more than one room. If the user is member of more than one room, the rooms are indicated on tabs 118. Selecting one of the other rooms will display an interface for that room.

In its preferred embodiment, the virtual meeting room is persistent, meaning that its state is preserved even when all members are logged out, or even as members are added and deleted. The state is typically preserved until the room is deleted. All documents, messages, reminders and history and other elements are preferably part of the state of the room unless otherwise specified.

If a user has sufficient rights, a member can manage the room and add and delete users by selecting the “Manage Room” link 120. Selecting link 122 allows a member to configure the member's contact information and other preferences.

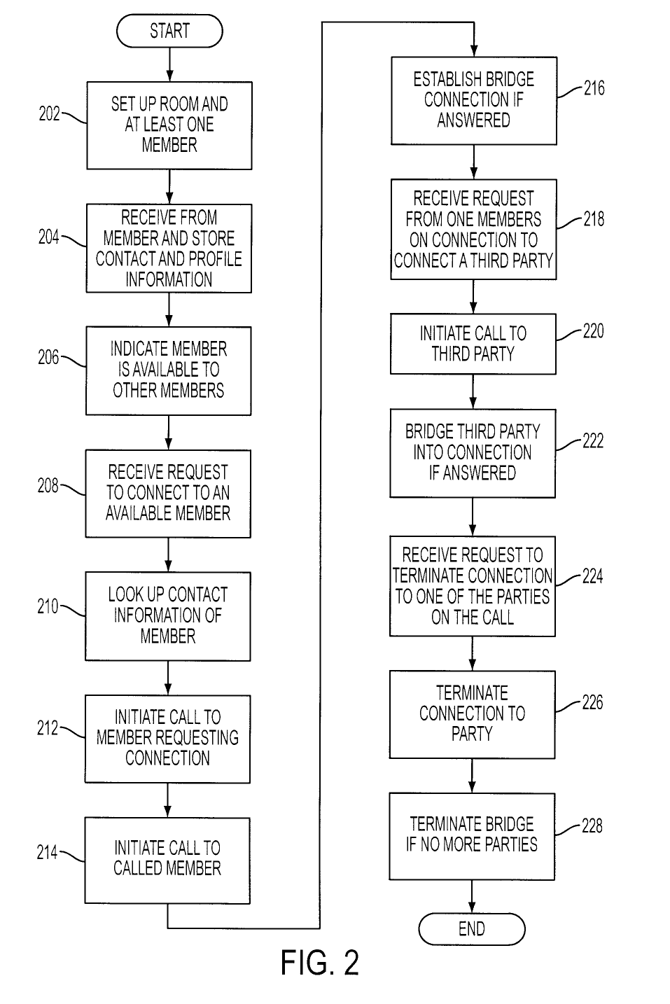

Referring now to FIG. 2, the illustrated flow chart represents an example of a typical process for members to set up and communicate through the virtual meeting room server using a browser interface, such as the one illustrated in FIG. 1. A meeting room is set up at step 202 by or on behalf of an organizer or administrator, who may or may not be a member of the room. One or more members are also set up. One or more members who are managers could be permitted to invite or set up new members. Optionally, emails are automatically sent to each member, notifying them of the membership and requesting them to login to change password information, set preferences and enter contact information.

A member securely logs into the server and configures methods for contacting the member, if any, at step 204. The methods of contact include all the ways that the user may want to be considered available to the other users within the room. Examples of the methods of contact include, but are not limited to, standard telephone numbers, universal location identifiers, Instant Messaging (IM) addresses, or email addresses.

Once the member has defined methods for contacting the member, the member defines one or more profiles, which consists of one or more of the methods of contact just configured. Each profile has a unique name that is configurable by the member. The member then specifies the profile that the member wishes to be made known to the other users within the room. Preferably, a member's availability can be configured to be global—applied to all rooms in which he or she is a member—or individually by sphere.

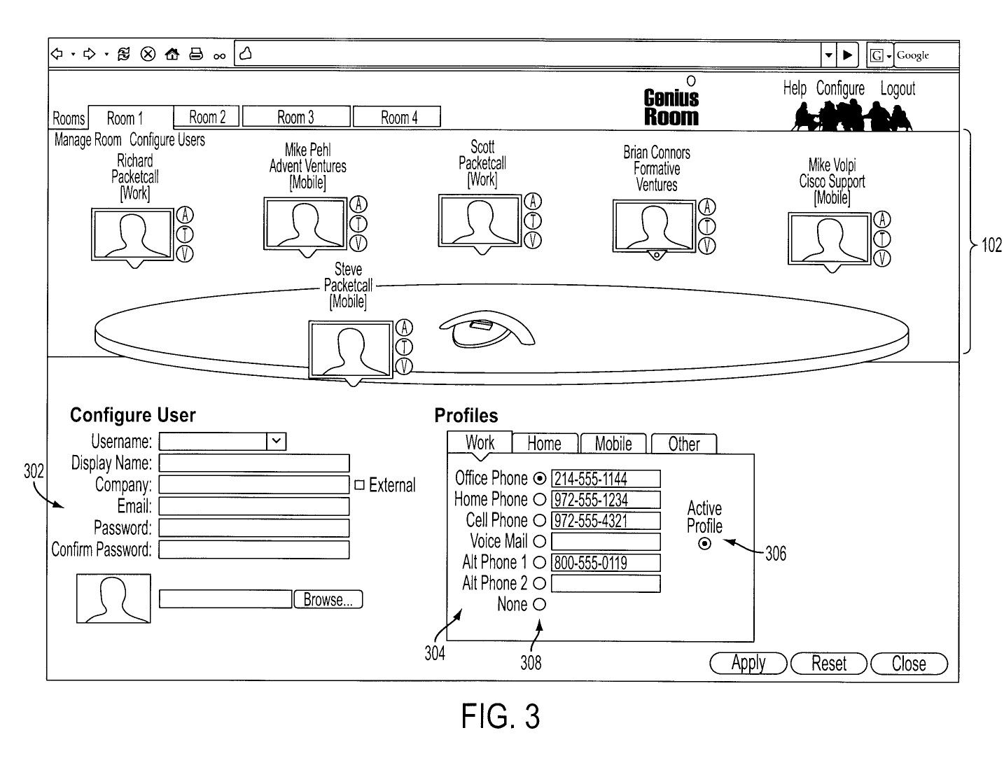

FIG. 3 comprises a representative example of a user configuration interface in the form of a webpage in a browser, through which a member provides contact and profile information. In the fields in region 302 basic member information is entered: display name, company, email address (for receiving notifications of new files and new messages directed to the member); new password and a picture. Region 304 presents a plurality of tab windows, each corresponding to a profile. In this example, the profiles includes “work”, “home”, “mobile” and “other.” A member indicates which of the profiles is active using a selector 306 (in this example, a radio button). Each profile window includes multiple fields for entering methods of contact. In this example, fields are provided for entry of numbers for office, home and cell telephones, voice mail, and alternate telephones. The member indicates which of these numbers the member is to be contact at using radio buttons 308. The profiles provide an easy mechanism for allowing a member to quickly select a different number at which to be reached. The user can designated a different profile and a different method of contact for each of room of which the user is a member. Profiles need not be static, but could change dynamically in response to certain conditions or parameters. For example, a user could set up profiles based on day, date, or time, and whether the member is busy on a call.

Returning to FIG. 2 at step 206, the virtual meeting room server indicates in the web page served to each member (or provides this information to a client application for those users who use a dedicated application) whether or not each member of the room is available for contact.

When one member wishes to contact another member, the member desiring to initiate contact selects (using normal keystroke or mouse selection techniques) an icon associated with the other member in the interface. A request to connect to the member is received by the server, as indicated by step 208. The server looks up the method of contact specified for each member on the connection. Then, it attempts first to connect to the member initiating the connection using the methods of contact contained in initiating member's profile, as indicated by step 212. Once that is successful, it initiates, as indicated by step 214, a connection to the other member. If that connection is successful, a communication bridge is established at step 216. Neither member needs to have any knowledge of the method of contact contained in the other's profile. Furthermore, this information is preferably not shared with any other member. In the example illustrated by the figure, the connection is a voice call. However, the communications session can be over any type of communication infrastructure, such as the PSTN (including cellular or mobile networks), PBX, wireless and/or wired computer networks (LAN, WAN, and Internet) or combinations of them, whether by voice, instant messaging or chat, video or other application.

Additional members can similarly be added to the connection. All members can be permitted to communicate on the same connection if the bridging facility is capable of supporting them. Steps 218, 220 and 222 illustrate an example of this process. One of the members already on the connection initiates a connection to one of the other members by simply selecting the member's icon. The server initiates a call to that third member, using that member's specified method of contact, and bridges the member in once the member answers, or terminates the connection if the member does not answer. Any member on the connection can request dropping a member (including itself) from the connection by selecting its icon, as indicated by steps 224 and 226. Allowing any member once on a connection to add new members and to drop members, rather than just the connection organizer, avoids problems when a connection organizer decides to drop off before the conference among the members is completed. As indicated by step 228, once all parties drop off the connection, the bridge is terminated.

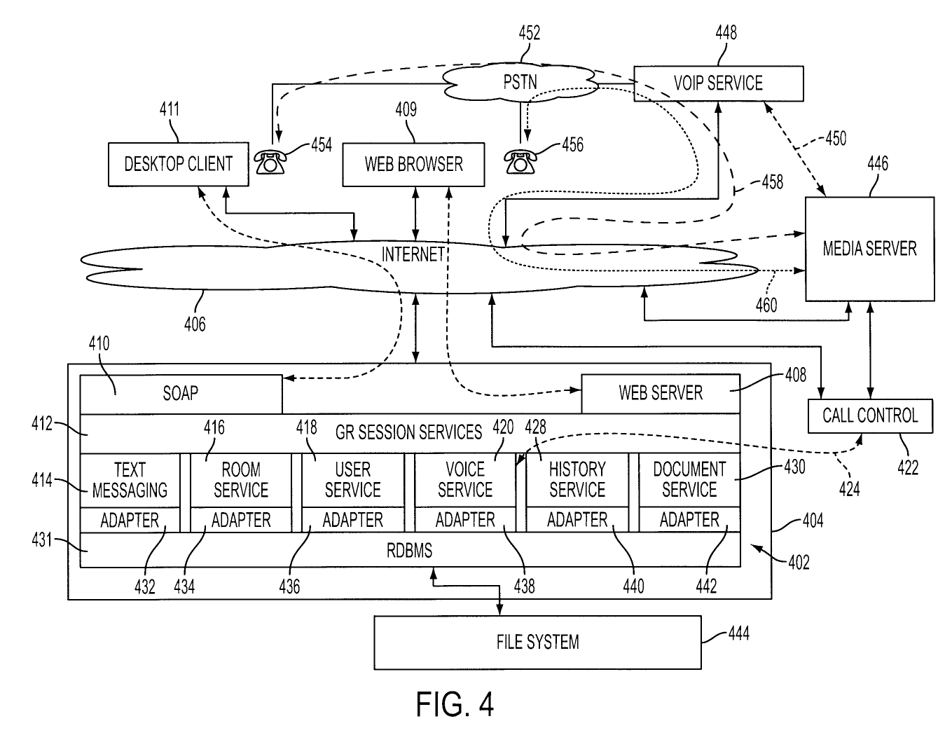

FIG. 4 comprises a block schematic illustration of an instance of a virtual room server 402 running on a general-purpose computer 404. The computer includes one or more high bandwidth network interfaces (not indicated) that enable communication through local and, optionally, wide area networks and, as seen in the illustrated example, Internet 406.

In this example, the virtual meeting room server communicates through a web server 408 or a SOAP (Simple Object Access Protocol) interface 410. The web server interface responses to HTTP requests from web browsers, such as web browser instance 409, which is running on a computer connected to the virtual room server through Internet 406. The web browser could also be on a computer on the same local area network (LAN) or wide area network (WAN) as the virtual meeting room server. The SOAP interface communicates with non-browser implementations of clients. One example is desktop client instance 411. Like the web browser instance, it is running on a computer connected to SOAP interface 410 through the Internet 406, but could also be on the same computer or on a different computer on the same LAN or WAN as the virtual meeting room server. Other interfaces could be implemented as well, depending on the nature of the client. GR session layer 412 is an abstraction layer that provides syntax and protocol mapping in order to enable the core logic of the server to interact with different interfaces, such as the web server and the SOAP interface.

The core logic of the server is implemented as modules to allow for expansion of additional modules. In this example, text messaging module 414 implements the messaging service described above. Room service 416 implements processes for creating and managing virtual rooms. User functions, including for example, the logic for interfacing with a user to receive methods of contact and generating the status, and storing contact information are implemented by user service 418. Voice service 420 provides logic for interacting with members and sending commands to call controller 422 to initiate, terminate and bridge voice calls. This communication is indicated by dashed line 424. In this example, remote method invocation (RMI) is used to communicate between the voice service module and the call controller 422. However, other methods and protocols can be used. History service 428 manages recording and tracking of the events for each virtual room. Document service 430 manages the files posted or otherwise available to each room. File types that can be posted or stored are not limited strictly to documents per se. Any form of data that can be stored as a file can be stored as a document and managed by the document service. Examples of file types include those storing voice, video, audio, recorded conferences, executable programs and database reports.

Each of these services stores data in one or more databases. In this example a relational database management system (RDBMS) 431 is being used, but other types of database systems could be employed. Database adapters 432, 434, 436, 438, 440 and 442 provide class to table conversion for respective services modules. File system 444 stores files for the document service 430. The document service works through the RDBMS to access the file system. This file system can be on the same computer or on a different computer. It may also take the form of a document repository or archiving application. File service can be set up to access more than one type of file system, which can be located on other computers, either on the same LAN or WAN as the virtual meeting room server, or on another network.

To set up bridges for voice calls between members using a process such as the one described in connection with FIG. 2, call controller 422 communicates with media server 446 using a standard protocol such as SIP. The media server, like the call controller, can be hosted on the same computer or on another computer on the same LAN as the virtual meeting room server 402, but it can also be hosted remotely. The media server establishes the physical bridge connection between members. In this example it includes one or more interfaces to Internet 406. The media server signals, using for example the SIP protocol, a voice over IP (VoIP) service 448, as indicated by dashed line 450. It is contemplated in this example that the VoIP server is connected to the Internet 406, though it could be connected through other communication means, or it could even reside on the same host. The VoIP sever includes or is connected to a gateway (not indicated) that has an interface to the PSTN. The VoIP server uses SS7 or other standard signaling protocol for communicating with switches on the public switched telephone network (PSTN) 452, depending on the type of interface being used. Thus, signaling generated by the media sever is passed onto the PSTN when the method of contacting a member specified by the member is a telephone number that must be routed through the PSTN. The PSTN routes the connection to mobile or fixed line telephones of members, through additional networks if necessary. In this example, telephones 454 and 456 are associated with two members, one using web browser instance 409 and the other using desktop client instance 411. If the contact does not involve routing the call through the PSTN, the VoIP service 448 can be used to establish a VoIP connection to other VoIP servers, or it can be bypassed, and a gateway service to the communication medium or network required for making the connection contacted instead to make the necessary connection. The foregoing is just an example of one configuration of a communication infrastructure that can be used with the virtual media server. No particular configuration is intended to be implied.

The figure illustrates an example call routing of the type described in FIG. 2. One of the two members initiated the call through either the instances of the web browser interface or desktop client. The other member need not be logged in to the virtual meeting room service to be contacted. Call controller 422 initiates, and the invocation of the voice service 420, a call to the member initiating the call. Once that connection, which is indicated by dashed line 458 (or dashed line 460, depending on which member is initiating the call) is completed, the call controller initiates a connection between the media server and the member being called. Once the two connections are made, the media server bridges the two connections. Additional connections can be added to the bridge, or eliminated from the bridge, at the request of the members through a client interface (web browser or application) without the members knowing anything about the underlying communications infrastructure or each other's contact information. Thus, the virtual meeting room server provides click-to-call and conferencing functionality. Similar functionality could be provided for video conferencing. Connections to non-members can be supported by, for example, including an interface for entering the contact information and passing it to the call controller.

In this example, the call controller 422 is assumed to be on the same computer or on a computer on the same local network as the server. However, a call controller hosted by a third party can also be utilized. The ability to use desktop software telephones can also be supported. Signaling interfaces to PBX, presence servers, and other standards compliant communications equipment could also be included. The virtual room server includes, or makes use of otherwise installed, email gateways (not indicated) so that members can be invited to a new or existing member, or be contacted as their preferred method of contact from members of a sphere.

Metrics or statistics are preferably gathered and analyzed so that, if so desired, use of the method can be metered and charged for use. Examples of various metrics and statistics gathered include the creation, activity within, and closure of a virtual room. These metrics can be used to search for patterns, or bill for feature use.

The virtual meeting room server 402 can exist in several instances on multiple computers. Furthermore, its components can be distributed among several computers. Components, such as the web server, RDBMS, and SOAP interface, could be shared with other processes if desired. FIG. 4 is intended only as a representative example. Certain capabilities of the virtual meeting room server can be implemented in other types of applications in which groups are formed and require or desire capabilities similar to one or more of those of the virtual meeting room server example. The claimed subject matter is not intended to be limited to this particular type of implementation unless explicitly included in a claim. Additional capabilities that can be included in the virtual meeting room server include audio recording of telephone calls, which can be added as document to the room.

Some additional advantages of exemplary, preferred embodiments described above include one or more of the following. The preferred embodiments provide a secure environment that can be hosted internally or externally to the enterprise or service provider. The client side software is relative simple, and requires only a commercially available browser. The service is scalable to very large sizes, up to millions of users, as a communications infrastructure overlay. It provides user call control that enables multi-party calls. Document posting, external document searching, and external document repository searching can be made available. History of all events and activities occurring within the room are automatically recorded. A number of different functions can be provided, such as alerts, reminders, notes and text messaging capability.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” or “steps for” are followed by a participle.

1. In a social or business collaboration or networking service, a method for enabling communication comprising:
storing contact information provided by a plurality of members comprising a predefined group;
transmitting information relating to the group to each of the plurality of members requesting information for a display in a user interface, the information including an indication of the availability of each of plurality of users without displaying the contact information provided by the plurality of users;
receiving through a user input into the interface a request by first one of the plurality members to contact a second one of the plurality of members; and
looking up the contact information provided by the second one of the plurality of members and attempting to establish a connection between the first of the plurality of members and the second one of the plurality of members.

2. A computer-implemented method for providing a group collaboration service over a computer network, comprising:
storing in at least one database contact information a plurality of members comprising a predefined group, each of the plurality of members separately supplying the contact information for that member, the contact information for the plurality of members being stored in a manner that does not permit a member of the group to see contact information supplied by any other member of the group;
transmitting information over at least one network to at least one remote computing device that at least one of the members of the group is using, the information including an indication relating to the availability of users for being contacted without displaying the contact information provided by the plurality of users;
receiving a request to contact a first member of the group to a second member of the group; and
looking up the contact information provided by the first and second member; and
initiating establishment a communication connection between the first member and the second member using the stored contact information of the first member and the second member.

3. The method of claim 2, wherein the stored contact information supplied by the members of the group is selected from a group comprising a standard telephone number, universal location identifier, instant messaging (IM) address, and email address.

4. The method of claim 2, wherein transmitting information over at least one network to at least one remote computing device further comprises transmitting information for displaying a graphically representation on the remote computing device a virtual meeting room, the virtual meeting room comprising one or more information sharing services for facilitating sharing of information between to members of the group to exclusion of others with no privileges relating the group.

5. The method of claim 4, wherein the one or more information sharing services comprises a file repository available to members of the group, wherein the representation of the virtual meeting room is comprised of an interface for accessing files stored in the file repository.

6. The method of claim 4, wherein the virtual meeting room is comprised of a text messing service for enabling members of the group to post messages available to other members of the group through the virtual room.

7. The method of claim 4, wherein transmitting information further comprises transmitting information indicating presence of a member in the virtual meeting room.

8. The method of claim 4, wherein the information transmitted over at least one network further comprises a web page.

9. The method of claim 4, wherein the information transmitted over at least one network is formatted for use by an application running on the remote computer generating the graphical representation of the virtual meeting room.

10. The method of claim 4, wherein receiving the request is comprised of receiving a communication generated by the at least one remote computing device in response to a user interacting with the graphical representation of the virtual room, the graphical representation including a graphical representation of the second member.

11. The method of claim 2, wherein the communication connection is comprised of a communication medium selected from a group consisting of telephone, instant messaging and email.

12. The method of claim 2, further comprising:
receiving a request from one of the first and second members to add a third member of the group to the communication connection; and
initiating addition of the third member to the communication connection.

13. The method of claim 2, wherein initiating establishment of a communication connection is comprised of automatically setting up a call between the first and second members using a bridge using numbers in the contact information stored for the first and second members.

14. The method of claim 2, wherein each of the plurality of members of the group sets up a profile, the profile specifying availability of the member to be contacted and contact information.

15. Apparatus for providing virtual meeting room services over a network, each virtual meeting room having a plurality of members, the apparatus comprising:
means for storing in at least one database contact information a plurality of members comprising a predefined group, each of the plurality of members separately supplying the contact information for that member, the contact information for the plurality of members being stored in a manner that does not permit a member of the group to see contact information supplied by any other member of the group;
means for transmitting information over at least one network to at least one remote computing device that at least one of the members of the group is using, the information including an indication relating to the availability of users for being contacted without displaying the contact information provided by the plurality of users;
means for receiving a request to set up a communication connection between a first member and a second member of the group; and
means for looking up the contact information provided by the first and second member and initiating establishment a communication connection between the first member and the second member using the stored contact information of the first member and the second member.

16. The apparatus of claim 15, wherein the stored contact information supplied by the members of the group is selected from a group comprising a standard telephone number, universal location identifier, instant messaging (IM) address, and email address.

17. The apparatus of claim 15, wherein the means for transmitting information over at least one network to at least one remote computing device further comprises means for transmitting information for displaying a graphically representation on the remote computing device a virtual meeting room, the virtual meeting room comprising one or more means for facilitating sharing of information between to members of the group to exclusion of others with no privileges relating the group.

18. The apparatus of claim 17, wherein the one or more means for facilitating sharing of information comprises a file repository available to members of the group, wherein the representation of the virtual meeting room is comprised of an interface for accessing files stored in the file repository.

19. The apparatus of claim 17, wherein the virtual meeting room is comprised of a text messing service for enabling members of the group to post messages available to other members of the group through the virtual room.

20. The apparatus of claim 17, wherein transmitting information further comprises transmitting information indicating presence of a member in the virtual meeting room.

21. The apparatus of claim 17, wherein the information transmitted over at least one network further comprises at least one web page.

22. The apparatus of claim 17, wherein the information transmitted over at least one network is formatted for use by an application running on the remote computer generating the graphical representation of the virtual meeting room.

23. The apparatus of claim 17, wherein the means for receiving the request is comprised of means for receiving a communication generated by the at least one remote computing device in response to a user interacting with the graphical representation of the virtual room, the graphical representation including a graphical representation of the second member.

24. The apparatus of claim 15, wherein the communication connection is comprised of a communication medium selected from a group consisting of telephone, instant messaging and email.

25. The apparatus of claim 15, further comprising:
means for receiving a request from one of the first and second members to add a third member of the group to the communication connection; and
means for initiating addition of the third member to the communication connection.

26. The apparatus of claim 15, wherein means for initiating establishment of a communication connection is comprised of means for automatically setting up a bridge between the first and second members using numbers in the contact information stored for the first and second members.

27. The apparatus of claim 15, further including means for setting up a profile for each member of the group, the profile specifying availability of the member to be contacted and contact information.

28. A computer readable memory for providing virtual meeting room services over a network, each virtual meeting room having a plurality of members, the apparatus comprising:
a computer database for storing contact information for the plurality of members of the group, the contact information including information indicating availability for each of the members of the group for communication with other members of the group; and
at least one programmable computer adapted for generating virtual meeting room data for use by remote clients in generating a graphical representation of a virtual meeting room; the at least one computer further adapted for facilitating sharing of information between to members of the group using to exclusion of others with no privileges relating the group, the information including indications of the availability of each member of the group to accept communication connections from other members of the group; the at least one computer further adapted for setting up a communication connection between two or more of the members of the group using the contact information stored in the computer database in response to receiving a request for a communication connection from one of the members of the group through the virtual meeting room representation on one of the remote client.
